(19) United States
(12) Patent Application Publication
(10) Pub. No.: US 2006/0015715 A1
(43) Pub. Date: Jan. 19, 2006

(54) Automatically protecting network service from network attack

(76) Inventor: Eric Anderson, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/893,597

(22) Filed: Jul. 16, 2004

(51) Int. Cl. H04L 9/00

(52) U.S. Cl. 713/154

(57) ABSTRACT

A system for detecting and responding to an attack comprises a filter module, a node, a management module, and a test node. The filter module allows questionable messages to proceed. The node receives the questionable messages and maintains logical operations associated with the questionable messages within a restricted region. The management module resets the service node upon a network attack. The test node replays the node questionable messages to identify a new attack. A method of protecting against a network attack logs questionable messages and directs the questionable messages to a node. The method maintains logical operations associated with the questionable messages within a restricted region and identifies a network attack upon the node, which triggers an intrusion response. The intrusion response resets the node, replays the questionable messages within a test node to identify a new attack message, and adds the new attack message to the known attack messages.

### FIELD OF THE INVENTION

The present invention relates to the field of network security. More particularly, the present invention relates to the field of network security where a network service is susceptible to a network based intrusion.

### BACKGROUND OF THE INVENTION

Network services available over the Internet are susceptible to intrusion and attack by outsiders. Security from intrusion and attack is crucial for successful operation of a network service. Statistics from CERT® indicate that intrusion incidents are rapidly increasing. In 2000, 21,756 incidents were reported. In 2001, 52,658 incidents were reported. In 2002, 82,094 incidents were reported. And in 2003, 137,529 incidents were reported.

A number of methods are available for improving security for network services. One method is to develop patches to fix known vulnerabilities in software. With this approach, someone must identify a vulnerability that needs to be fixed. In some instances, vulnerabilities can be found by inspecting code or by experimentally attacking the software. More often, vulnerabilities are identified when an outsider discovers the vulnerability and exploits it to gain access to one or more computers or to wreak havoc within one or more computers. Developing a patch is a time consuming process even after the vulnerability has been identified. First, the particular software code that the vulnerability exploits must be identified. Then, someone must write new code that eliminates the vulnerability and, hopefully, does not add a new vulnerability to the software.

Another method for improving network security for network services uses protected jails. For example, ftp daemons often use a chroot( ) system call to change a root directory for a file system for anonymous ftp. When this technique is employed, an anonymous ftp user will only be able to access a subset of the files within the machine being accessed. Another variation of a protected jail employs a virtual machine. When an intrusion occurs that exploits a vulnerability on a virtual machine, exposure to the vulnerability is limited to the virtual machine. Another variation of a protected jail employs programs such as Janus that allow administrators to configure an allowed set of system calls that can be made by an application. Another variation of a protected jail restricts privileges for users. For example, http daemons often run with a user set to “nobody” in order to limit vulnerabilities and to limit damage that can be caused by available vulnerabilities.

One problem with protected jails is that they limit functionality. For example, chroot( ) is not used for web servers because they often access files outside of a single sub-directory tree. The other protected jails improve security but often once an intruder successfully exploits a vulnerability within a protected jail, the user can exploit other vulnerabilities to increase privileges and gain access outside of the protected jail.

Another method of improving security for network service employs intrusion detection systems. An intrusion detection system observes activities occurring over network links or within computer systems looking for suspicious activity. When suspicious activity is observed, the intrusion detection system notifies a system administrator. It is then up to the system administrator to determine whether the suspicious activity indicates an intrusion and, if so, to respond to it.

Another method of improving security for network service is firewalls. A firewall helps prevent attacks by limiting network packets that can proceed beyond the firewall. Most rely on simple rules for identifying port or IP (internet protocol) addresses. More advance firewalls can match patterns within a packet. Firewalls protect against known attacks but will not protect against an unknown attack from an allowed port.

While these methods improve security for network services, they leave opportunities for outsiders to identify unknown vulnerabilities and to exploit them.

What is needed is a method of automatically protecting a network service from a network attack.

### SUMMARY OF THE INVENTION

According to an embodiment, the present invention is a system for automatically detecting and responding to a network attack. The system comprises a filter module, a service node, a management module, and a test node. The filter module receives network messages and blocks known attack messages, which each include one or more known attack patterns. This reduces the network messages to questionable messages. The service node couples to the filter module. The service node receives at least a portion of the questionable messages, which form node questionable messages. The service node maintains logical operations associated with the node questionable messages within a restricted region that comprises the service node. The service node comprises a monitoring system which identifies a network attack. The management module couples to the service node. The management module resets the service node upon the monitoring system identifying the network attack. The test node couples to the management module. The test node comprises a test node monitoring system. The test node replays the node questionable messages received by the service node at about a time of the network attack. The test node monitoring system identifies a new attack pattern that caused the network attack. The management module then adds the new attack pattern to the known attack patterns.

According to another embodiment, the present invention is a method of automatically protecting a network service from a network attack. The method begins with a first step of filtering known attack messages from network messages received by the network service. This reduces the network messages to questionable messages. A second step logs the questionable messages. A third step directs at least a portion of the questionable messages to a service node. This forms node questionable messages. A fourth step identifies a network attack upon the service node. This triggers an intrusion response. According to an embodiment, the intrusion response comprises fifth, sixth, and seventh steps. The fifth step resets the service node. The sixth step replays at least a subset of the node questionable messages within a test node to identify a new attack pattern which instituted the network attack. The seventh step adds the new attack pattern to the known attack patterns.

These and other aspects of the present invention are described in more detail herein.

### BRIEF DESCRIPTION OF THE DRAWINGS

The present invention is described with respect to particular exemplary embodiments thereof and reference is accordingly made to the drawings in which:

FIG. 1 schematically illustrates an embodiment of a system for automatically detecting and responding to a network attack of the present invention;

FIG. 2 schematically illustrates an embodiment of another system for automatically detecting and responding to a network attack of the present invention;

FIG. 3 schematically illustrates an embodiment of yet another system for automatically detecting and responding to a network attack of the present invention; and

FIG. 4 illustrates an embodiment of a method of automatically protecting a network service from a network attack of the present invention as a flow chart.

### DETAILED DESCRIPTION OF A PREFERRED EMBODIMENT

According to an aspect, the present invention comprises a method of automatically protecting a network service from a network attack. According to another aspect, the present invention comprises a system for automatically detecting and responding to the network attack.

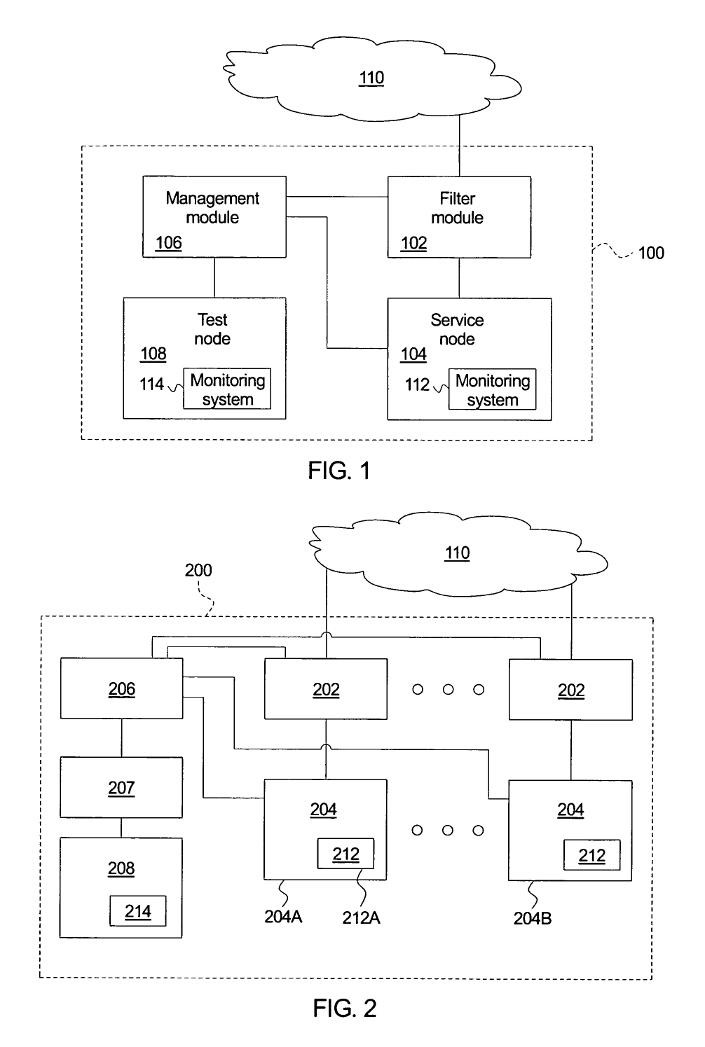

An embodiment of a system for automatically detecting and responding to a network attack is illustrated schematically in FIG. 1. The system 100 comprises a filter module 102, a service node 104, a management module 106, and a test node 108. The filter module 102 couples to an external network 110. According to an embodiment, the external network 110 comprises the Internet. According to another embodiment, the external network 110 comprises a wide area network. According to yet another embodiment, the external network 110 comprises a local area network.

The filter module 102 couples to the service node 104. According to an embodiment, the filter module 102 comprises a separate node. According to another embodiment, the filter module 102 forms part of the service node. According to other embodiments, the filter module 102 comprises a front-end computer, a router, a switch, or a bridge. According to an embodiment, the service node 104 comprises a virtual machine. According to another embodiment, the service node 104 comprises a separate computer. The management module 106 couples to the service node 104 and the test node 108. According to an embodiment, the management module 106 and the filter module 102 comprise separate nodes. According to another embodiment, the management module 106 and the filter module 102 comprise a single node.

In operation, the filter module 102 receives network messages from the external network 110. The filter module 102 blocks known attack messages from proceeding further into the system 100 by recognizing known attack patterns. According to an embodiment, the filter module 102 applies filter rules to the network messages to identify and block the known attack messages. According to an embodiment, the filter rules comprise a set of fingerprints for the known attack patterns. According to this embodiment, the filter module identifies the known attack messages by comparing the network messages to the set of fingerprints. According to another embodiment, the filter rules comprise a list of network addresses, network prefixes, network ports, or a combination thereof. According to this embodiment, the filter module 102 identifies the known attack messages by comparing the network messages to the list of the network addresses, the network prefixes, the network ports, or the combination thereof. According to yet another embodiment, the filter rules comprise a Bayesian filtering technique. According to this embodiment, the filter module 102 applies the Bayesian filtering technique to the network messages to identify the known attack messages.

The filter module 102 allows questionable messages to proceed to the service node 104. The questionable messages are the network messages which remain after blocking the known attack messages. The service node 104 maintains logical operations associated with the questionable messages within a restricted region. According to an embodiment, a virtual machine monitor isolates the restricted region from a remainder of the system 100. According to an embodiment, the restricted region comprises the service node 104. The service node 104 includes a monitoring system 112 for identifying a network attack. The monitoring system 112 watches for an attack upon the service node 104. According to an embodiment, the monitoring system 112 identifies an attack by noting an invalid invocation of a system resource. According to another embodiment, the monitoring system 112 identifies an attack by noting an unauthorized change to a file. According to another embodiment, the monitoring system 112 identifies an attack by noting an unauthorized priority elevation of a process. According to another embodiment, the monitoring system 112 identifies an attack by noting an invalid system call. According to another embodiment, the monitoring system 112 identifies an attack by noting a disallowed variation in a system resource.

Upon the monitoring system 112 identifying a network attack, the management module 106 resets the service node 104. According to an embodiment in which the service module 102 comprises a virtual machine, the management module 106 resets the service node 104 by restarting the virtual machine. According to an embodiment in which the service node 102 comprises a separate computer, the management module 106 resets the service node 102 by toggling power to the separate computer. According to another embodiment, the management module 106 resets the service node 102 by sending a message to the service node 102 to reboot or to reset its state. According to an embodiment, a reset operation for the service node 102 lets in-progress requests finish within a short period of time in order to avoid user perception of a service interruption.

According to an embodiment, the management module directs the test node 108 to begin replaying at least a subset of the questionable messages in a step-by-step process. According to an embodiment, the replay of the questionable messages comprises replaying the questionable messages which had active operations in progress on the service node 104 at a time of the network attack. According to another embodiment, the replay of the questionable messages comprises replaying the questionable messages which were received within a time period of the network attack. According to this embodiment, the replay of the questionable messages further comprises replaying the questionable messages which were received within a longer time period of the network attack if the time period proves insufficient for identifying the new attack message. According to another embodiment, the replay of the questionable messages comprises replaying a virtual machine's execution on an instruction-by-instruction basis. According to another embodiment, the replay of the questionable messages comprises classifying the subset of the questionable messages into a suspect group and a non-suspect group and replaying the suspect group. According to this embodiment, the replay of the questionable messages further comprises replaying the non-suspect group if the suspect group does not include the new attack message.

The test node 108 includes a test node monitoring system 114. When the test node replays the attack message which caused the network attack, the test node monitoring system 114 identifies a new attack pattern and forwards it to the management module 106. The management module 106 then modifies the filter rules to include the new attack pattern. According to an embodiment, the management module 106 modifies the filter rules by adding a new filter rule. According to another embodiment, the management module modifies the filter rules by modifying one or more existing filter rules.

According to an alternative embodiment, the system 100 further comprises a tracing system (not shown), which couples the management module 106 to the test node 108. According to an embodiment, the tracing system receives the questionable messages from the filter module 102 and logs the questionable messages (e.g., within a circular buffer). According to an embodiment, the tracing system controls the test node 108 during the step-by-step process of replaying the questionable messages.

According to another alternative embodiment, the management module 106 records state changes made to the service node 104. Later when the management module 106 resets the service node 104 upon the network attack, the management module 106 applies the state changes to the service node 104. According to an embodiment, a system operator is prompted to review post-attack state changes before the post-attack state changes are applied to the service node 104 in order to prevent inadvertently reinstituting the network attack.

Another embodiment of a system for automatically detecting and responding to a network attack is illustrated schematically in FIG. 2. The system 200 comprises filter modules 202, service nodes 204, a management module 206, a tracing system 207, and a test node 208. The filter modules 202 couple to the external network 110. The filter modules 202 also couple to the service nodes 204. Preferably, each of the filter modules 202 couples to a distinct one of the service nodes 204 so that a first filter module couples to a first service node, a second filter module couples to a second service node, etc. Alternatively, one or more of the filter modules 202 couple to a plurality or pluralities of the service nodes 204. The management module 204 couples to the service nodes 204 and the tracing system 207. The tracing system 207 couples to the test node 208.

In operation, the filter modules 202 receive network messages from the external network 110, block known attack messages, and forward questionable messages to the service nodes 204. Concurrent with the forwarding of the questionable messages to the service nodes 204, the tracing system 207 logs the questionable messages. Each of the service nodes 204 maintains logical operations associated with the questionable messages which it receives within a restricted region. In other words, a first service node 204A that receives first questionable messages maintains logical operations associated with the first questionable messages within a first restricted region; and a second service node 204B that receives second questionable messages maintains logical operations associated with the second questionable messages within a second restricted region. According to an embodiment, the first restricted region comprises the first service node 204A and the second restricted region comprises the second service node 204B.

Each of the service nodes 204 includes a monitoring system 212. Each of the monitoring systems 212 observes activities within the service node 204 which comprises it. Upon a network attack of the first service node 204A, a first monitoring system 212A identifies the network attack and notifies the management module 206. The management module 206 then resets the first service node 204A and directs the tracing system 207 to identify a new attack message which caused the network attack. The tracing system 207 then replays the first questionable messages in a step-by-step process on the test node 208 until the new attack message is identified. The test node 208 comprises a test node monitoring system 214. The test node monitoring system 214 identifies the new attack message which includes a new attack pattern and forwards the new attack pattern to the management module 206. The management module 206 then updates the filter rules, which adds the new attack pattern to the known attack patterns.

According to an alternative embodiment, the system 200 comprises additional management modules. According to this embodiment, each of the management modules manages a single service node or a group of service nodes. According to another alternative embodiment, the system 200 comprises additional tracing systems 207. According to this embodiment, each of the tracing systems logs questionable messages for a single service node or a group of service nodes. Also according to this embodiment, a particular tracing system that logs questionable messages for a particular service node replays the questionable messages on the test node 208.

According to another alternative embodiment, the system 200 comprises additional test nodes. This embodiment provides a better response capability over an embodiment comprising a single test node for at least two reasons. First, the system 200 will be able to more quickly respond to multiple simultaneous attacks. Second, the system 200 will be able to more quickly respond to a particular attack by dividing the questionable messages suspected of causing a network attack into groups and simultaneously replaying a first group on a first test node, a second group on a second test node, etc. According to an embodiment, the test nodes are coupled to the tracing system 207. According to another embodiment, the test nodes are couple to a plurality of tracing systems.

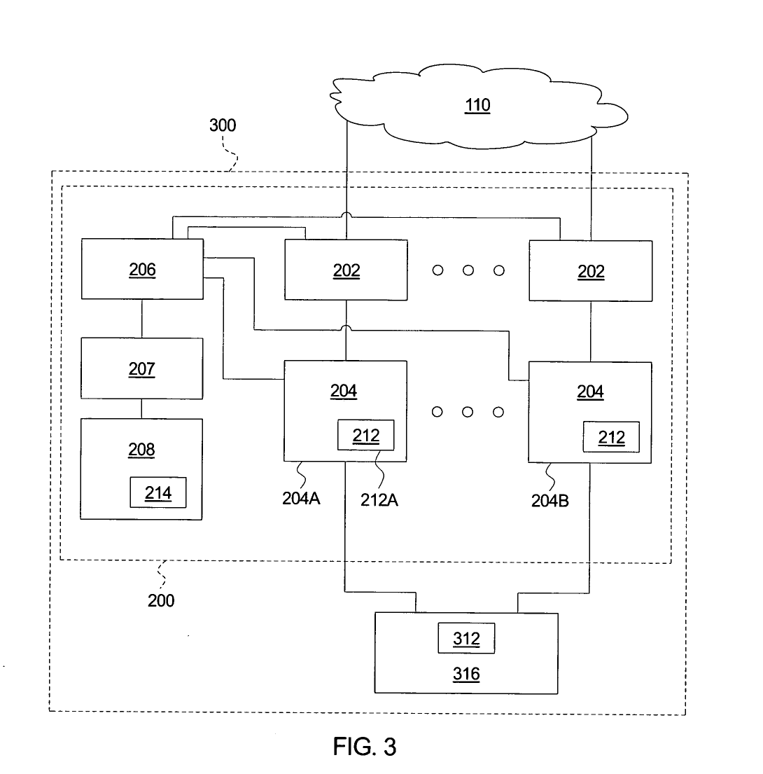

Another embodiment of a system for automatically detecting and responding to a network attack is illustrated schematically in FIG. 3. The system 300 comprises the system 200 and a backend 316. The backend 316 couples to the service nodes 204. The backend 316 extends a restricted region for each of the service nodes 204.

The system 300 operates similarly to the system 200 with the exception that the backend performs processes for or provides data to the service nodes 204 in response to request messages from the service nodes 204. Each of the service nodes 204 maintains logical operations associated with questionable messages that it receives within the restricted region for the service node. In other words, the logical operations associated with the questionable messages received by the first service node 204A are maintained within a first restricted region, which comprises the first service node 204A and the backend 316; and the logical operations associated with the questionable messages received by the second service node 204B are maintained within a second restricted region, which comprises the second service node 204B and the backend 316. In order to preclude a network attack directed to the backend 316, the backend 316 maintains logical operation within a backend restricted region.

In operation, the service nodes 204 send the request messages to the backend 316 and the tracing system 207 logs the request messages. The backend 316 comprises a backend monitoring system 312, which recognizes a network attack upon the backend 316. The management module 206 then resets the backend 316 and the tracing system 207 replays the request messages on the test node 208 in a step-by-step process. This continues until the test node monitoring system 214 identifies an attack request message that caused the network attack. The tracing system 207 or the management module 206 then correlates the attack request message to the questionable message responsible for the network attack (i.e., the new attack message). The management module 206 then updates the filter rules to add the new attack pattern to the known attack patterns.

According to an alternative embodiment of the system 300, the system 300 further comprises an additional management module, tracing system, test node, or a combination thereof dedicated to supporting the backend 316.

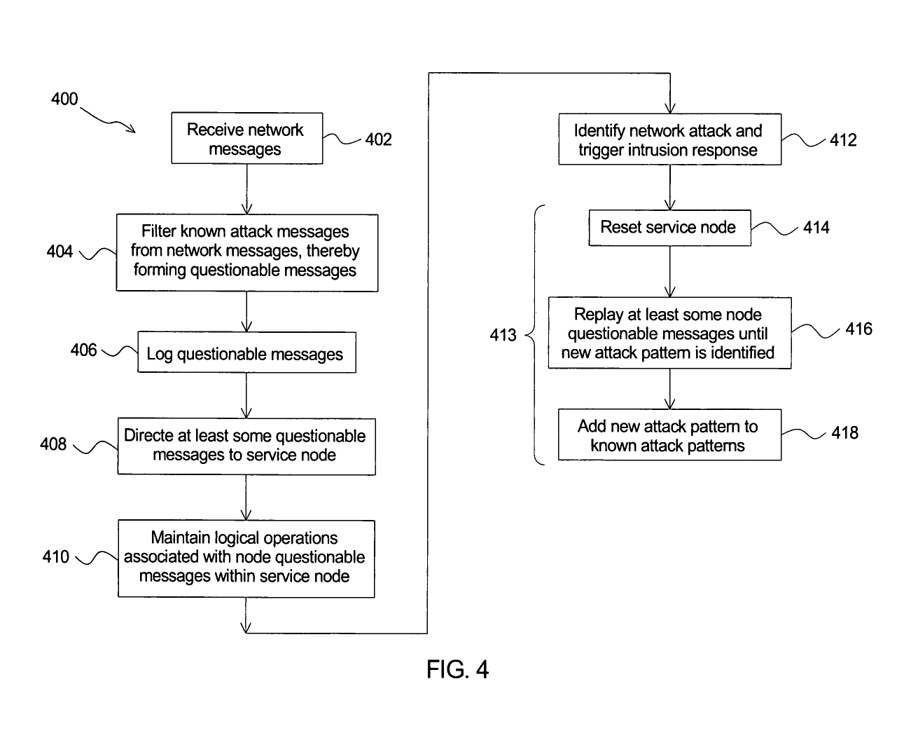

An embodiment of a method of automatically protecting a network service of the present invention is illustrated as a flow chart in FIG. 4. The method 400 begins with a first step 402 of receiving network messages from an external network. A second step 404 filters known attack messages from the network messages. This reduces the network messages to questionable messages. A third step 406 logs the questionable messages. A fourth step 408 directs at least a portion of the questionable messages to a service node. According to an embodiment, the service node comprises a virtual machine. According to another embodiment, the service node comprises a stand alone computer.

According to an embodiment, the method 400 continues with a fifth step 410 of maintaining logical operations associated with the questionable messages within the service node. According to another embodiment, the method 400 does not perform the fifth step 410. A sixth step 412 identifies a network attack upon the service node and triggers an intrusion response 413. According to an embodiment, the intrusion response 413 begins with a seventh step 414 of resetting the service node. The intrusion response 413 continues with an eighth step 416 of replaying at least a subset of the node questionable messages to identify a new attack message that instituted the network attack. According to an embodiment, the intrusion response 413 concludes with a ninth step 418 of adding a new attack pattern to the known attack patterns by modifying the filter rules.

Once the filter rules have been modified in the ninth step 418, the method 400 has accomplished its goal of automatically protecting the network service from the network attack. Later, a system operation can notify a software vendor responsible for the software which was the subject of the network attack. In this way, a patch can be developed for the new attack and the appropriate intrusion response teams can be notified of the new attack message and the patch that avoids it. Once the patch has been installed on the system employing the method 400, the filter rules can be modified to delete the new attack pattern since the patch will prevent the network attack.

The foregoing detailed description of the present invention is provided for the purposes of illustration and is not intended to be exhaustive or to limit the invention to the embodiments disclosed. Accordingly, the scope of the present invention is defined by the appended claims.

What is claimed is:

1. A system for automatically detecting and responding to a network attack comprising:
a filter module which receives network messages and blocks known attack messages, thereby reducing the network messages to questionable messages;
a service node coupled to the filter module which receives at least a portion of the questionable messages, thereby forming node questionable messages, and which maintains logical operations associated with the node questionable messages within a restricted region comprising the service node, the service node comprising a monitoring system which identifies a network attack;
a management module coupled to the service node which resets the service node upon the monitoring system identifying the network attack; and
a test node coupled to the management module and comprising a test node monitoring system, the test node replaying the node questionable messages received by the service node at about a time of the network attack, the test node monitoring system identifying a new attack pattern that caused the network attack, the management module adding the new attack pattern to known attack patterns.

2. The system of claim 1 wherein the filter module comprises a frontend computer.

3. The system of claim 1 wherein the filter module comprises a router, a switch, a bridge, or a combination thereof.

4. The system of claim 1 wherein the filter module comprises a portion of the service node.

5. The system of claim 1 wherein the restricted region further comprises a backend.

6. The system of claim 5 wherein the backend comprises a backend monitoring system.

7. The system of claim 1:
wherein the service node comprises a first service node, the logical operations comprise first logical operations, the restricted region comprises a first restricted region, the monitoring system comprises a first monitoring system, and the network attack comprises a first network attack; and
further comprising a second service node.

8. The system of claim 7 wherein:
the second service node comprises a second monitoring system;
the second service node receives a subset of the questionable messages; and
the second service node maintains second logical operations associated with the subset of the questionable messages within a second restricted region comprising the second service node.

9. The system of claim 8 wherein the second monitoring system identifies a second network attack.

10. The system of claim 8 wherein the first service node further comprise a first backend.

11. The system of claim 10 wherein the second service node further comprises a second backend.

12. The system of claim 11 wherein the first and second backends comprise a single node.

13. The system of claim 1 further comprising additional service nodes.

14. The system of claim 1 wherein the management module comprises a separate node.

15. The system of claim 1 wherein the management module and the filter module comprise a single node.

16. The system of claim 1 wherein the service node comprises a virtual machine.

17. The system of claim 1 wherein the service node comprises a stand alone computer.

18. The system of claim 1 further comprising a tracing system coupling the management module to the test node.

19. The system of claim 18 wherein the tracing system logs the questionable messages.

20. The system of claim 19 wherein the tracing system controls replay of the node questionable messages on the test node.

21. The system of claim 1 wherein the management module controls replay of the node questionable messages on the test node.

22. A system for automatically detecting and responding to a network attack comprising:
a filter module which receives network messages and blocks known attack messages, thereby reducing the network messages to questionable messages;
a service node coupled to the filter module which receives at least a portion of the questionable messages, thereby forming node questionable messages, and which maintains logical operations associated with the node questionable messages within a restricted region comprising the service node, the service node comprising a monitoring system which identifies a network attack;
a management module coupled to the service node which resets the service node upon the monitoring system identifying the network attack;
a tracing system which logs the questionable messages; and
a test node coupled to the tracing system and comprising a test node monitoring system, the tracing system directing the test node to replay the node questionable messages received by the service node at about a time of the network attack, the test node monitoring system identifying a new attack pattern that caused the network attack, the management module adding the new attack pattern to known attack patterns.

23. A method of automatically protecting a network service from a network attack comprising the steps of:
filtering known attack messages from network messages received by the network service, thereby reducing the network messages to questionable messages;
logging the questionable messages;
directing at least a portion of the questionable messages to a service node, thereby forming node questionable messages;
identifying a network attack upon the service node which triggers an intrusion response; and
the intrusion response comprising the steps of:
resetting the service node;
replaying at least a subset of the node questionable messages within a test node to identify a new attack pattern which instituted the network attack; and
adding the new attack pattern to known attack patterns.

24. The method of claim 23 further comprising the step of maintaining logical operations associated with the node questionable messages within a restricted region which comprises the service node.

25. The method of claim 23 wherein the step of filtering the known attack messages comprises applying filter rules to the network messages.

26. The method of claim 25 wherein the step of adding the new attack pattern to the known attack patterns comprises modifying an existing filter rule.

27. The method of claim 25 wherein the step of adding the new attack pattern to the known attack patterns comprises adding a new filter rule.

28. The method of claim 23 wherein the step of filtering the known attack messages comprises comparing the network messages to a set of fingerprints for the known attack messages.

29. The method of claim 23 wherein the step of filtering the known attack messages comprises comparing the network messages to a list of network addresses, network prefixes, or network ports associated with the known attack messages.

30. The method of claim 23 wherein the step of filtering the known attack messages comprises using Bayesian filtering to statistically identify the known attack messages.

31. The method of claim 23 wherein the step of identifying the network attack comprises identifying invalid invocations of system resources.

32. The method of claim 23 wherein the step of identifying the network attack comprises scanning files in search of unauthorized changes.

33. The method of claim 23 wherein the step of identifying the network attack comprises scanning processes in search of unauthorized priority elevations of processes.

34. The method of claim 23 wherein the step of identifying the network attack comprises identifying invalid system calls.

35. The method of claim 23 wherein the step of identifying the network attack comprises checking for disallowed variations in system resources.

36. The method of claim 23 wherein the step of replaying at least the subset of the node questionable messages comprises replaying the node questionable messages which had active operations in progress on the service node at the time of the network attack.

37. The method of claim 23 wherein the step of replaying at least the subset of the node questionable messages comprises replaying the node questionable messages which were received within a time period of the network attack.

38. The method of claim 37 wherein the step of replaying at least the subset of the node questionable messages further comprises replaying the node questionable messages which were received within a longer time period of the network attack upon determining the time period was insufficient for identifying the new attack message.

39. The method of claim 23 wherein the step of replaying at least the subset of the node questionable messages comprises replaying the node questionable messages in reverse chronological order until the new attack message is identified.

40. The method of claim 23 wherein the step of replaying at least the subset of the node questionable messages comprises the steps of:
classifying the subset of the node questionable messages into a suspect group and a non-suspect group; and
replaying the suspect group.

41. The method of claim 40 wherein the step of replaying at least the subset of the node questionable messages comprises the steps of:
determining that the suspect group does not include the new attack message; and
replaying the non-suspect group.

42. The method of claim 23 further comprising the step of recording state changes to the service node.

43. The method of claim 42 wherein the step of resetting the service node comprises applying the state changes to the service node.

44. The method of claim 43 wherein a system operator reviews post-attack state changes before applying the post-attack state changes to the service node.

45. A computer readable memory comprising computer code for implementing a method of automatically protecting a network service from a network attack, the method of automatically protecting the network service from the network attack comprising the steps of:
filtering known attack messages from network messages received by the network service, thereby reducing the network messages to questionable messages;
logging the questionable messages;
directing at least a portion of the questionable messages to a service node, thereby forming node questionable messages;
identifying a network attack upon the service node which triggers an intrusion response; and
the intrusion response comprising the steps of:
resetting the service node;
replaying at least a subset of the node questionable messages within a test node to identify a new attack message which instituted the network attack; and
adding the new attack message to the known attack messages.
